(19) United States
(12) Patent Application Publication
(10) Pub. No.: US 2026/0051314 A1
(43) Pub. Date: Feb. 19, 2026

(54) SYSTEM

(71) Applicant: SOFTBANK GROUP CORP., Tokyo (JP)

(72) Inventor: Naoaki SATAKE, Tokyo (JP)

(73) Assignee: SOFTBANK GROUP CORP., Tokyo (JP)

(21) Appl. No.: 19/299,436

(22) Filed: Aug. 14, 2025

(30) Foreign Application Priority Data
Aug. 16, 2024 (JP) 2024-137096

(51) Int. Cl. G10L 13/033; G10L 13/047; G10L 15/26; G10L 15/30

(52) U.S. Cl. CPC G10L 13/033; G10L 13/047; G10L 15/30; G10L 15/26

(57) ABSTRACT

A system includes a processor that is configured to record a user's voice, transmit the recorded voice to a server, analyze the audio data at the server to generate a voice profile, perform transcription based on the voice profile, set parameters for voice synthesis, assign a unique identifier to the audio data, generate synthetic voice, and enable the user to download the generated voice data.

### CROSS-REFERENCE TO RELATED APPLICATION

This application claims priority under 35 USC 119 from Japanese Patent Application No. 2024-137096 filed Aug. 16, 2024, the disclosure of which is incorporated by reference herein in its entirety.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems for utilizing personal voice data face several issues, including the inability to accurately reproduce a user's natural voice characteristics, difficulties in preventing unauthorized use or forgery of generated voice data, and a lack of mechanisms for users to monetize their own voices. Additionally, when a user loses their ability to speak temporarily or permanently, there is no seamless method for conveying their intended messages using their own unique voice.

### SUMMARY

To address these problems, the present invention provides a system including a processor configured to record a user's voice, transmit the recorded voice data to a server, analyze the audio to generate a voice profile, perform transcription based on the voice profile, set parameters for voice synthesis, and assign a unique identifier to the audio data. The processor further generates synthetic voice and enables the user to download the generated voice data. The system utilizes a speech recognition engine for analysis and an identifier generation algorithm to enhance security and data authenticity, thereby enabling accurate reproduction of voice characteristics, secure management of voice data, and facilitating new opportunities for users to utilize and monetize their synthesized voices.

“Processor” means a physical or virtual computing unit that executes instructions to perform specific operations as described in the system.

“User's voice” means the audio input generated by a human user when speaking.

“Audio data” means electronic data representing digitized sounds, including speech recorded from the user.

“Voice profile” means a collection of data describing characteristic features and individual traits of a specific user's voice, such as pitch, tone, and accent.

“Transcription” means the process of converting spoken language in the audio data into written text.

“Voice synthesis” means the generation of artificial speech output from text data, replicating the characteristics defined in the voice profile.

“Unique identifier” means a code or data string, such as an NFT or hash value, assigned to audio data to distinguish it from other data and prevent unauthorized use.

“Speech recognition engine” means a software or hardware module that automatically analyzes audio data to recognize and process human speech.

“Identifier generation algorithm” means a computational method or process for producing unique identifiers assigned to audio data.

“Server” means a remote computing system that receives, stores, processes, and manages audio data and related computational tasks.

“Terminal” means a user-operated device, such as a smartphone or computer, which records the user's voice and communicates with the server.

“Synthetic voice” means electronically generated speech output produced by the system, intended to closely replicate the user's own voice.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions; and

FIG. 10 illustrates an emotion map mapping plural emotions.

FIG. 11 is a sequence diagram showing the flow of data processing system processing in Example 1.

FIG. 12 is a sequence diagram showing the flow of data processing system processing in Application Example 1.

FIG. 13 is a sequence diagram showing the flow of data processing system processing in Example 2.

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

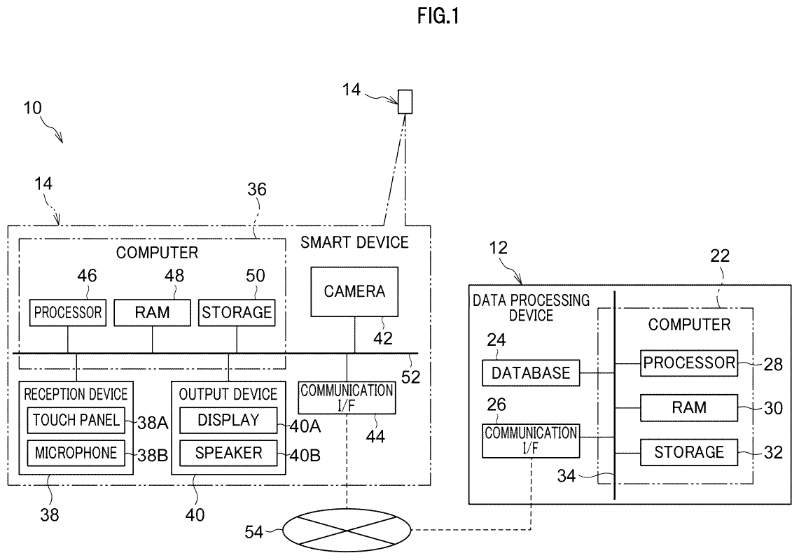

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

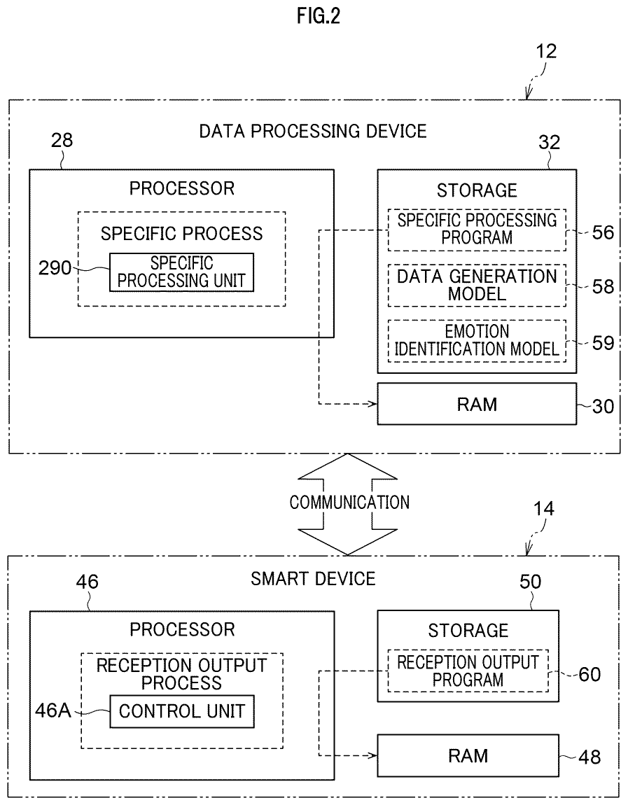

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional systems that utilize acoustic information, such as voice data, require users to perform multiple manual steps, including recording, analyzing, transcribing, and generating synthetic audio, often involving specialized knowledge and considerable effort. Furthermore, such systems lack sufficient mechanisms to prevent unauthorized use or forgery of voice data, resulting in issues related to security and rights management. There is therefore a need for an efficient and secure system that enables users to easily acquire, analyze, synthesize, and utilize their voice data, while also addressing problems of authenticity, rights management, and workflow automation.

The specific processing by the specific processing unit 290 of the data processing device 12 in Example 1 is realized by the following means.

The present invention provides a server including a processor configured to acquire user acoustic information, transmit the acquired acoustic information to an information processing apparatus, analyze the acoustic information to generate acoustic feature information, execute character encoding based on the acoustic feature information, set control variables for synthetic acoustic information, assign unique codes to the acoustic information, generate synthetic acoustic information using generative intelligence models with directive text as input, assign unique identifiers for rights or distribution management, and automatically perform at least a portion of these processes in an integrated control manner. This enables users to efficiently and securely utilize their acoustic information with minimal manual operation, prevent unauthorized use or forgery, and streamline the entire process from acquisition to utilization and rights management.

The term “acoustic information” refers to data representing sounds produced by a user, including voice, speech, or other audio signals, which are captured in a digital or analog format.

The term “information processing apparatus” refers to an electronic device or system capable of performing operations on digital data, including analysis, storage, computation, and communication functions.

The term “acoustic feature information” refers to a dataset extracted from acoustic information, including characteristics such as pitch, tone, speed, timbre, and other measurable properties relevant to the user's voice or audio signal.

The term “character encoding processing” refers to the process of converting acoustic information into a textual or symbolic digital representation, such as transcribing spoken words into written text.

The term “control variables” refers to parameters used to adjust the output or quality of synthesized acoustic information, such as pitch, tone, speed, and other aspects that define the generated audio.

The term “unique code” refers to an identifier that is exclusively associated with a piece of acoustic information, which distinguishes it from other data and is used for tracking, authenticity, or rights management.

The term “synthesized acoustic information” refers to artificially generated audio data produced by processing textual information and acoustic features, typically using a generative intelligence model to resemble or reproduce the characteristics of the original user's voice.

The term “generative intelligence model” refers to a computational algorithm, such as an artificial intelligence or machine learning system, that is capable of generating new data (such as audio) from input conditions, including directive sentences or other control information.

The term “directive sentence” refers to an input text or instruction provided to a generative intelligence model, specifying the content or purpose of the synthesized acoustic information to be generated.

The term “unique identifier” refers to a code or symbol that serves to distinguish a data item, such as synthesized acoustic information, facilitating its management in rights administration, distribution, or ownership verification.

The term “integrated control manner” refers to a method in which multiple processes within the system are automatically and harmoniously managed and executed without requiring manual intervention for each step.

An embodiment of the present invention can be realized by a system in which a server, a terminal, and a user interact to process acoustic information efficiently and securely. The main hardware components include an information processing device (such as a general-purpose server or cloud server), a user terminal (such as a smartphone, tablet, or personal computer), and communication networks to facilitate data transfer.

The server may be implemented using general-purpose hardware, such as a cloud-based server, and software including a web application server (for example, using open-source frameworks), a database system (such as PostgreSQL or MySQL), and application logic for audio processing and management. The terminal can be any device equipped with a microphone and storage capability, running a dedicated application for recording, sending, and receiving acoustic information.

The user operates the terminal by launching the recording application and providing acoustic information through the terminal's microphone. The terminal digitizes the acoustic signal, stores the data locally, and transmits it to the server via a secure network protocol such as HTTP or HTTPS. Software on the terminal may include audio recording libraries and HTTP clients, typically available on platforms like Android or iOS.

The server receives the acoustic information and processes it by first extracting essential features using audio analysis libraries, such as open-source signal processing tools (e.g., pyAudioAnalysis, LibROSA), and then stores this data in a secure database for further processing. The server next utilizes a speech recognition engine (for example, a generic speech-to-text API) to convert the acoustic data into textual information and generates an acoustic feature profile by analyzing properties such as pitch, tone, and speed.

The server also manages generation of synthesized acoustic information. For this, the server uses a generative AI model or text-to-speech engine (such as a generic deep learning-based voice synthesis library or commercial text-to-speech service) with the user's acoustic feature profile and desired directive sentence as input. Control parameters, including pitch, tone, and speed, can be set by the server to produce the synthetic audio output that matches the user's unique voice characteristics. To ensure authenticity and enable rights management, the server assigns a unique identifier, such as a cryptographic hash or digital asset token, to each acoustic information item and the corresponding synthesized data. This process is partially or fully automated through integration logic in the server's software.

The system may provide a user interface or application through which the user can download or play the synthesized acoustic information, by sending a request from the terminal to the server. The server then delivers the corresponding audio file, which the terminal stores and enables the user to play via a standard media player.

As an example, suppose the user wishes to create and distribute a synthetic voice for use in a presentation scenario. The user records a message on their smartphone, such as “Hello, my name is John Smith. Please proceed to the next slide.” The terminal processes the recording, transmits the data to the server, and the server extracts features and generates synthesized speech emulating the user's voice based on the directive sentence. The user then downloads and uses the synthetic voice file in the presentation, ensuring both usability and data integrity.

Prompt sentence examples for use with a generative AI model may include:

“Please convert my recorded message into text: ‘Hello, my name is John Smith.’”

“Synthesize the following text using my stored voice profile: ‘Please proceed to the next slide.’”

“Register my synthetic voice data for secure distribution and rights management.”

Through these processes, the present invention allows users to efficiently utilize their acoustic information for a wide range of applications, while addressing the requirements of automation, security, and rights administration using a combination of general-purpose information processors, standard communication protocols, and advanced audio processing software.

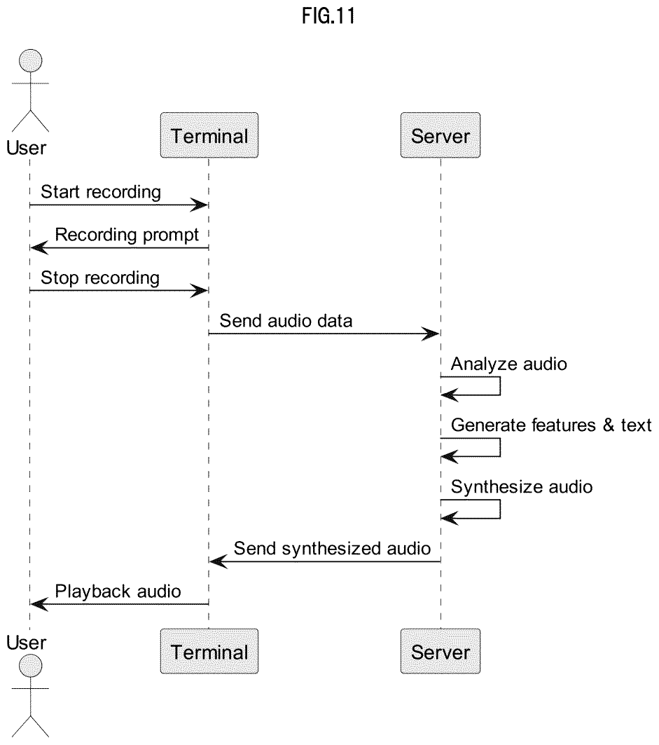

The following describes the processing flow using FIG. 11.

### Step 1

The user launches the recording application on the terminal and taps the “Start Recording” button. The terminal activates its microphone to capture the user's acoustic information.

Input: User's spoken voice through the microphone.

Data processing: The terminal digitizes the analog audio signals and temporarily stores the digital audio data (e.g., WAV or MP3 file) in its local storage.

Output: Digitized acoustic information file stored on the terminal.

### Step 2

The user taps the “Stop Recording” button to end the recording. The terminal finalizes and saves the acoustic information file in a designated directory.

Input: Ongoing digital audio data buffer.

Data processing: The terminal completes the recording session and writes the complete file to storage, ensuring file integrity.

Output: Complete acoustic information file ready for transmission.

### Step 3

The terminal generates an HTTP request with the acoustic information file attached. The terminal adds metadata such as user ID, timestamp, and file format to the request headers and sends the file to the server via a secure network connection.

Input: Acoustic information file and associated user metadata.

Data processing: The terminal packages the audio file and metadata into an HTTP POST request and transmits it to the server endpoint.

Output: HTTP request received by the server.

### Step 4

The server receives the HTTP request containing the acoustic information file. The server validates the input, extracts the audio file and metadata, and stores them in the appropriate storage location and database.

Input: HTTP request containing the raw acoustic information and metadata.

Data processing: The server checks the file format and size, saves the file to persistent storage, and records metadata in the database.

Output: Verified and database-registered acoustic information file.

### Step 5

The server retrieves the stored acoustic information file and analyzes it using an audio feature extraction library. The server extracts features such as pitch, tone, and speed to generate acoustic feature information.

Input: Acoustic information file from storage.

Data processing: The server processes the raw audio data, performs signal analysis, extracts relevant features, and forms a structured feature dataset.

Output: Acoustic feature information set.

### Step 6

The server applies a speech recognition engine to the acoustic information to perform character encoding and generate a transcription of the user's voice.

Input: Acoustic information file or extracted features.

Data processing: The server uses the engine to convert speech signals into text, optionally including timestamps and confidence scores.

Output: Textual data representing the user's spoken content.

### Step 7

The server links the transcription and acoustic feature information with the original audio and stores all associated data in the database.

Input: Transcription, acoustic feature set, audio file metadata.

Data processing: The server associates the data items, organizes them for rapid retrieval, and stores the linked dataset.

Output: Integrated record of audio file, transcription, and features in the database.

### Step 8

The server generates a unique code for the acoustic information and related data by applying a unique code generation algorithm (e.g., cryptographic hash).

Input: Acoustic information data and associated metadata.

Data processing: The server computes the unique code and updates the database to store this code with the corresponding records.

Output: Data with assigned unique identifier for authenticity and rights management.

### Step 9

The server generates synthesized acoustic information using a generative AI model. The server combines the acoustic feature information and a directive prompt sentence as input to the AI model and produces a synthetic voice output emulating the user.

Input: Acoustic feature information and prompt sentence (e.g., “Please proceed to the next slide.”).

Data processing: The server sets control variables (pitch, tone, speed), invokes the generative AI model with the input text and features, and generates the synthesized audio.

Output: Synthesized acoustic information file matching the user's voice characteristics.

### Step 10

The server assigns a unique identifier for rights or distribution management to the generated synthesized acoustic information for secure tracking and utilization.

Input: Synthesized acoustic information data.

Data processing: The server updates the database, links the unique identifier to the synthetic audio, and ensures access control for distribution or commercialization.

Output: Managed and securely identified synthesized acoustic information.

### Step 11

The user requests to download the synthesized acoustic information through the terminal. The terminal sends a request to the server referencing the appropriate unique identifier or data record.

Input: User request via terminal, identifier for specific synthetic audio.

Data processing: The terminal sends an HTTP GET request to the server to retrieve the corresponding file.

Output: Download request received by the server.

### Step 12

The server retrieves the synthesized acoustic information linked to the unique identifier and transmits it to the terminal for user access.

Input: Download request and unique identifier.

Data processing: The server locates the correct file, prepares the data for download, and sends it via HTTP to the terminal.

Output: Synthesized acoustic information file delivered to the terminal.

### Step 13

The terminal receives the synthesized acoustic information, stores it locally, and allows the user to play it via an application media player.

Input: Synthesized acoustic information file from the server.

Data processing: The terminal saves the file in local storage, updates the media library, and enables playback for the user's selected application use-case.

Output: Playable synthetic audio available to the user.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional voice authentication and speech synthesis systems suffer from insufficient accuracy, reliability, and security. In particular, it is difficult to prevent unauthorized use of individual voice characteristics, ensure high-precision user authentication, and generate synthetic speech that can reflect both the personal features and emotional nuances of a user. Additionally, there are challenges in securely managing rights and identifiers associated with generated speech data as well as enabling commercial or secondary usage of such data while maintaining traceability and control.

The specific processing by the specific processing unit 290 of the data processing device 12 in Application Example 1 is realized by the following means.

The present invention provides a server including a processor configured to obtain user audio information, analyze it to generate voice feature information and emotion information, generate linguistic information accordingly, set synthesis control parameters, generate speech synthesis information, assign unique identification information using a cryptographic or digital identification function, store related information, transmit the resulting speech synthesis information to user terminals, and manage rights and playback or provision of the generated speech data. This enables highly accurate and secure voice authentication, the generation of synthetic speech with personalized and emotional attributes, and robust control over identification and rights management for both personal and commercial use of voice data.

The term “audio information” refers to data representing sounds produced by a user, including but not limited to spoken words, captured as analog or digital signals by an input device.

The term “information processing apparatus” refers to an electronic device, such as a computer, server, mobile device, or dedicated terminal, configured to execute applications or process input data.

The term “communication network” refers to any wired or wireless data transmission infrastructure that enables the exchange of information between remote devices.

The term “voice feature information” refers to a set of data that characterizes the unique acoustic properties of a user's voice, such as pitch, tone, accent, frequency components, and speaking rate.

The term “linguistic information” refers to text or symbolic data generated by converting audio information into a written or machine-processable form, such as the transcription of spoken language.

The term “emotion information” refers to data representing the emotional state inferred from the user's audio information, including but not limited to categories such as happiness, sadness, anger, or neutrality.

The term “control information for speech synthesis” refers to a set of parameters, instructions, or configurations that guide the synthesis of audio signals to reproduce or emulate specified acoustic and emotional qualities.

The term “individual identification information” refers to a unique identifier assigned to audio or speech synthesis data, generated using algorithms such as cryptographic hashes or digital signature techniques, to ensure authenticity, traceability, or rights management.

The term “speech synthesis information” refers to data or a file generated by artificially creating an audio representation that replicates or simulates a user's voice, possibly incorporating personalized or emotional features.

The term “rights information” refers to data that defines, controls, or records usage rights, permissions, licenses, or ownership associated with audio information or speech synthesis information.

The term “storage device” refers to any hardware or virtual system, such as a database, memory, or cloud storage, used for preserving and organizing data persistently or temporarily.

The term “user terminal” refers to an electronic device operated by an end user, such as a smartphone, tablet, personal computer, or dedicated client device, that interfaces with the system for sending, receiving, or utilizing information.

The term “cryptographic algorithm” refers to a mathematical procedure or protocol used for generating secure, unique identifiers or for securing data to prevent unauthorized access or duplication.

The term “digital identification generation processing function” refers to a software or hardware routine that creates unique digital identifiers for data records, files, or content, enabling authentication, tracking, or rights enforcement.

The term “playback or external provision” refers to the outputting of generated speech synthesis information to a user for listening, or supplying such information to third parties or external systems under managed conditions.

An embodiment of the invention will now be described in detail with reference to the scope of the claims.

This invention may be implemented using an information processing system including a server equipped with at least one processor, a user terminal such as a smartphone or personal computer, input and output devices including a microphone and speaker, and a communication network enabling data exchange between the user terminal and the server.

The user utilizes a terminal to start an application providing a user interface for recording audio. The terminal may be a mobile device, a tablet, or a desktop computer with a recording capability such as an integrated or external microphone. The user operates the application, for example, by tapping a “record” button, and speaks a desired phrase into the microphone. The terminal digitizes the user's voice and stores the data temporarily on local memory. Examples of audio file formats include Waveform Audio (.wav) or MPEG-4 Audio (.mp3).

The terminal transmits the recorded audio data and related metadata (such as a user identifier and time information) to the server over a communication network. For this purpose, the terminal may employ secure HTTP protocols (such as HTTPS) and standard application-layer interfaces (APIs).

The server is configured to receive, store, and manage incoming audio information.

Using a speech recognition processing function, such as an automatic speech recognition (ASR) system, the server analyzes the audio information to extract voice feature information—the acoustic characteristics uniquely identifying the user's voice. The speech recognition engine may include software modules such as a large-vocabulary continuous speech recognizer or cloud-based ASR services (e.g., generic speech-to-text APIs or open-source frameworks). For emotion estimation, the server may use an emotion recognition engine based on a generative AI model, extracting emotional attributes from the acoustic data.

Subsequently, the server converts the audio information into linguistic information, such as transcribed text. The server further generates synthesis control information based on both voice feature information and, where applicable, emotion information. Parameters for speech synthesis are set accordingly to guide generation of speech output that replicates the user's personal voice characteristics and emotional tone.

In this process, the server assigns individual identification information, such as a cryptographic hash or a unique digital signature, to each audio or speech synthesis data set. This identification may be generated using a cryptographic algorithm or a digital identification generation processing function. All relevant data-including the original audio, extracted features, recognition results, emotion assessments, synthesis parameters, and unique identifiers may be stored persistently in databases or storage devices, which may include hard disk drives, solid-state drives, or cloud-based storage services.

The server generates speech synthesis information using a speech synthesis engine such as a text-to-speech system or neural TTS model. For example, the server may implement open-source synthesis engines or cloud-based text-to-speech APIs. The generated synthetic voice is tailored to convey not only the user's unique acoustic signature but also the inferred emotional state.

The synthetic audio, along with all associated identification and rights information, is made accessible to the user. The user retrieves the generated speech synthesis information using the terminal by issuing a request through the application interface—for example, by selecting a “download” or “playback” option. The server authenticates the request and securely transmits the audio file to the terminal, where it is saved for playback or further use.

The server is further configured to manage rights information associated with the generated speech synthesis data. The server may issue or register a digital license or token for each piece of synthesized audio, controlling its distribution, external provision, and usage conditions, including potential commercialization or external sharing on digital marketplaces.

The system is adaptable to a wide range of use cases, such as secure voice-based authentication, assistive communications, generation of personalized voice responses, or commercial voice data trading. For instance, a user who temporarily loses their own voice can use the system to generate emotional, personalized voice messages to be played in real time during presentations or events. Alternatively, the user may register their synthesized voice samples as unique digital assets with traceable identification on a marketplace.

A sample prompt sentence for the generative AI model used in the server is as follows: “Analyze my recorded voice sample, infer my emotional tone, and generate an audio file that reproduces my original voice characteristics and emotion, using the phrase: ‘Thank you, everyone, for attending today.’ Assign a unique identifier to the result and prepare the output for secure download.”

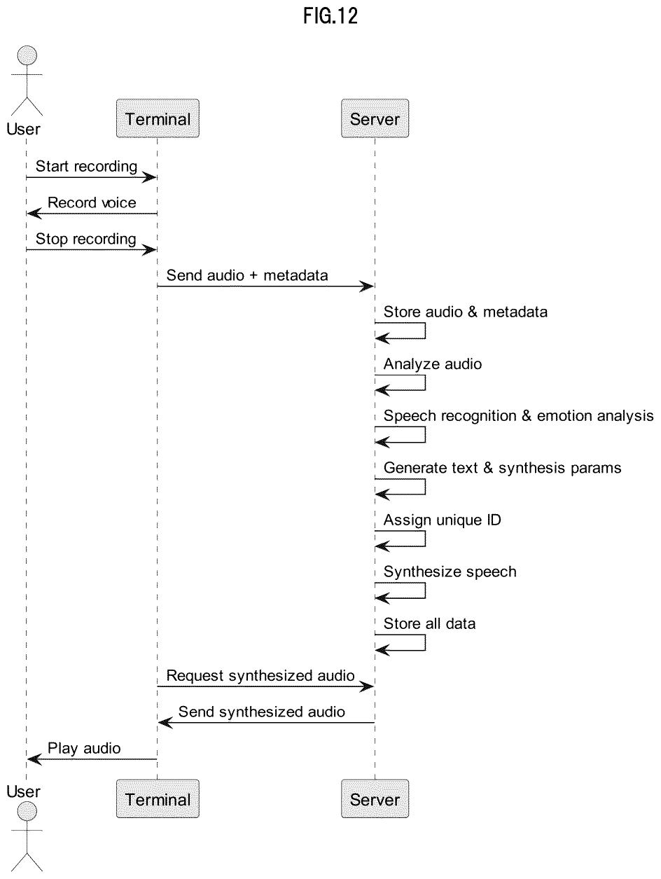

The following describes the processing flow using FIG. 12.

### Step 1

The user launches an application on the terminal and selects the voice recording function. The user presses the “Start Recording” button and speaks a designated phrase or message into the microphone. Input: The user's spoken voice. The terminal digitizes the audio, creating a digital audio file (such as a WAV or MP3 file) and saves it in the terminal's local storage. Output: A digital audio file containing the user's recorded voice.

### Step 2

The terminal prepares to upload the recorded audio file by generating a data packet that includes the audio file and metadata, such as user ID and timestamp. Input: The recorded digital audio file and associated metadata. The terminal sends this data to the server via an HTTP request over a communication network (such as Wi-Fi or mobile data). Output: An HTTP request containing the audio file and metadata sent to the server.

### Step 3

The server receives the HTTP request, extracts the audio file and metadata, and stores them in a storage device or database. Input: The HTTP request with audio file and metadata. The server parses and verifies the received data, saving the audio file to persistent storage and recording the associated metadata in a database. Output: The audio file and metadata securely stored on the server.

### Step 4

The server analyzes the audio file using a speech recognition engine and an emotion recognition module. Input: The audio file. The server invokes a generative AI model or speech recognition processing function to extract the user's voice feature information (such as pitch, tone, speech rate) and infers emotion (such as happy, neutral, or sad) from the audio data. Output: Voice feature information and emotion information generated from the audio file.

### Step 5

The server generates linguistic information by converting the audio file into a text transcription using the extracted voice features. Input: Voice feature information. The server processes the audio through automatic speech recognition, mapping sound patterns to words, and creates a text record corresponding to the user's speech. Output: Linguistic information (transcribed text) stored on the server.

### Step 6

The server sets control information for speech synthesis based on the voice features and inferred emotion. Input: Voice feature information and emotion information. The server configures synthesis parameters, such as pitch, timbre, speed, and emotional tone, according to the extracted data. Output: Speech synthesis control information containing all parameters required for personalized speech generation.

### Step 7

The server assigns individual identification information to the original audio file and synthetic data. Input: The audio file and synthesized data. Using a cryptographic algorithm or digital identification generation processing function, the server calculates a unique identifier (such as a hash value) and associates it with the stored data. Output: Audio file and synthetic data tagged with unique identification information.

### Step 8

The server generates speech synthesis information using a speech synthesis engine, guided by the control information. Input: Transcribed text and synthesis control parameters. The server instructs the synthesis engine to create a synthetic audio file that reproduces the user's unique voice characteristics and emotional tone, based on the given parameters. Output: A synthetic audio file representing the user's personalized and emotional voice.

### Step 9

The server stores the generated synthetic audio file, along with voice feature information, emotion information, unique identifier, and rights information, in a storage device. Input: Synthetic audio file and associated data. The server organizes and secures this data for retrieval, playback, or secondary use. Output: All relevant data securely stored and indexed in the server.

### Step 10

The user, via the terminal, requests to download or play back the generated synthetic audio file. Input: A user-issued download or playback request specifying the desired synthetic audio. The terminal sends a request to the server, which authenticates the request, retrieves the corresponding audio file, and transmits it to the terminal. The terminal saves or plays back the audio for the user. Output: The synthetic audio file delivered to the user and ready for playback or further use.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional audio synthesis systems have difficulty generating artificial voices that naturally reflect the emotional state of a user, and lack robust methods for assigning unique identifiers to audio data in order to prevent unauthorized use or forgery. Furthermore, users are often unable to easily access or download the generated audio content, which limits the practical usability and reliability of such systems.

The specific processing by the specific processing unit 290 of the data processing device 12 in Example 2 is realized by the following means.

The present invention provides a server including a processor configured to acquire user audio information, analyze the information to generate audio feature and emotional information, assign unique identification information, and generate and provide artificial audio based on these features and identifiers in response to user requests. This enables natural and emotion-reflective artificial voice generation, secure identification of audio data to prevent misuse, and efficient access for users to obtain the generated audio.

The term “audio information” refers to digitized acoustic data representing spoken sounds or utterances provided by a user.

The term “processor” refers to a hardware component or control unit capable of executing instructions and processing data according to programmed functionality.

The term “information processing device” refers to an electronic apparatus or computing platform configured to receive, analyze, and manipulate data, including audio and related information.

The term “audio feature information” refers to extracted characteristics from audio data, such as pitch, tone, amplitude, frequency, or other measurable acoustic features.

The term “linguistic information” refers to text or symbolic representation of human language derived from audio information, typically obtained through speech recognition.

The term “machine learning device” refers to a computational component or software module that utilizes algorithms to learn and recognize patterns, such as emotional content, from data including audio.

The term “emotional information” refers to data indicating the detected emotional state or affective expression present in the user's audio information.

The term “configuration information” refers to parameter settings or control variables used to determine the qualities of generated artificial audio, such as pitch or emotional tone.

The term “unique identification information” refers to a non-repeating code or marker assigned to audio information for the purpose of authenticating, tracking, or preventing unauthorized use.

The term “artificial audio” refers to synthesized or computer-generated speech that imitates or reproduces human voice based on input parameters.

The term “terminal device” refers to any user-facing electronic device capable of sending and receiving data, such as a smartphone, tablet, or computer.

The term “acquisition request” refers to a user-initiated action or command for obtaining or downloading generated artificial audio information from a server or processing device.

Embodiment for Implementing the Invention The present invention can be implemented by providing a system including a processor in a server and a terminal device accessible by a user. The server is connected to one or more databases and interacts with terminal devices, such as a smartphone or personal computer, via a network interface. The system may utilize general-purpose computing hardware, including a central processing unit (CPU), memory, storage, and network communication modules.

The user operates the terminal device to record their audio information using dedicated recording software or an application program, which may be implemented using standard frameworks such as the Android MediaRecorder API or iOS AVFoundation framework. The recorded audio information is digitally stored on the terminal device and includes the user's spoken message, which may range from a short greeting to a lengthy message.

The terminal device is configured to transmit the recorded audio information to the server through a standard communication protocol, such as HTTPS. The transmission can include associated metadata such as the recording timestamp and a user identifier.

Upon receiving the audio information, the server stores the data in a storage device, for example, an SSD drive, a relational database, or a cloud-based object storage service. The server analyzes the digital audio using audio processing software, such as Python with the Librosa library, to extract audio feature information, including pitch, amplitude, frequency, and rhythm characteristics. The audio information is further processed using an automatic speech recognition module such as a speech-to-text cloud service (e.g., a speech recognition API provided by a cloud platform) to generate linguistic information corresponding to the spoken content.

To recognize and add emotional information, the server applies a machine learning model, such as one built using a deep learning framework (e.g., TensorFlow or PyTorch), or uses a third-party emotion recognition API capable of detecting emotional attributes based on acoustic and linguistic features. The server adds the recognized emotional information, such as joy, anger, or sadness, to the data associated with the audio.

Based on the emotional information, the server determines configuration information, including parameter settings for artificial audio generation (for example, pitch, speech rate, and tone), by referencing predefined templates or dynamically calculating adjustments suitable for the particular emotion. The server assigns unique identification information to the audio information and related data by generating a non-repeating code (such as a UUID) or through cryptographic means.

The server synthesizes artificial audio using a speech synthesis engine, such as a text-to-speech API available from cloud service providers, using the linguistic information, configuration information, and user-specific audio feature information as inputs. This results in artificial audio that reflects the original speaker's vocal characteristics and recognized emotional state.

On receiving an acquisition request from the user, the server transmits the generated artificial audio to the user's terminal device via a secure network connection. The terminal device saves the received artificial audio information in its local storage and may allow the user to play back the artificial audio using the built-in audio player.

For example, a user may utilize the system to prepare an emotionally appropriate synthetic narration for a presentation. Suppose the user is unable to speak in real time during the presentation; the user can play the pre-generated artificial audio from their terminal device, which reflects their intended emotional nuance. Furthermore, the system allows users to commercialize their generated voices by making artificial audio accessible to other users under conditions managed by unique identification information.

Examples of prompt sentences for a generative AI model include:

“Explain how to use a pre-generated synthetic voice with emotional tone for delivering a message during a presentation when you lose your voice.”

“Describe the process for listing my own voice on a digital marketplace so that others can purchase and use my synthetic voice data.”

“Given a recorded audio file and emotional parameters, generate a synthetic speech that reflects the user's specific emotional state, and assign a unique identifier to prevent unauthorized use.”

“Explain, step-by-step, how a user can record their voice on a smartphone, send it to a server for emotion-aware text-to-speech synthesis, and receive a unique, forgery-resistant synthetic audio file for use in presentations or marketplaces.”

“Detail the process by which the server analyzes audio for emotion, sets synthesis parameters, generates a unique identifier, and creates an emotion-matching synthetic voice file for secure distribution.”

Through the above techniques, the system achieves the technical effect of enabling natural, emotionally expressive, and securely identifiable artificial audio generation, as well as reliable delivery and usability for users.

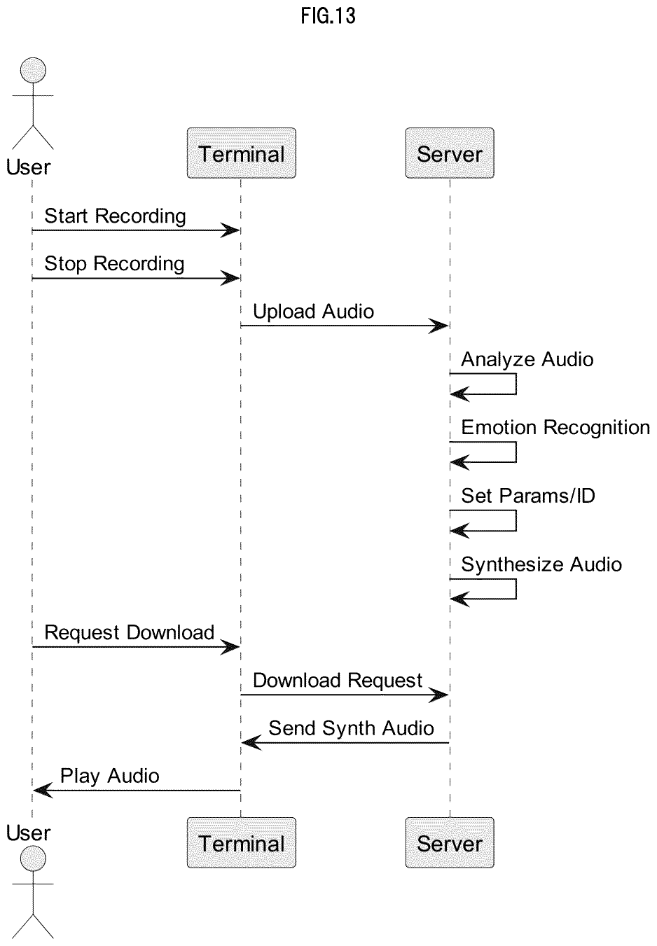

The following describes the processing flow using FIG. 13.

### Step 1

The user operates the terminal device to launch the dedicated recording application.

Input: User intention and manual operation (such as tapping “Start Recording”).

Output: Activation of the terminal's microphone and transition to the recording state. The terminal enables the built-in microphone and displays a recording interface, waiting for audio input.

### Step 2

The user speaks their message into the terminal's microphone.

Input: User's voice as an analog audio signal.

Output: Digital audio information stored in a temporary file format (such as WAV or MP3) on the terminal device.

The terminal digitizes the audio using an audio API and saves the data, along with metadata including time and user ID.

### Step 3

The user completes recording and initiates the upload process by tapping the “Stop Recording” button and a “Send” button in the application.

Input: User command to stop and upload, digital audio file.

Output: Prepared data packet containing the audio file and metadata.

The terminal finalizes the audio file, creates an HTTP POST request, attaches metadata, and readies the packet for transmission.

### Step 4

The terminal transmits the recorded audio information and metadata to the server over a network connection.

Input: Data packet containing audio file and metadata.

Output: Data transfer to the server and confirmation of successful upload.

The terminal sends the HTTP POST request to the server's REST endpoint and displays a message upon a successful transmission.

### Step 5

The server receives the audio data and stores it on persistent storage.

Input: HTTP POST request containing audio data and metadata.

Output: Audio file and metadata stored in the server's storage subsystem and database.

The server parses the request, saves the file (for example, to a storage device or cloud storage), and records metadata in the database.

### Step 6

The server analyzes the received audio information to extract audio feature information and generates a transcription.

Input: Audio file and metadata.

Output: Audio feature information and linguistic information (transcription).

The server applies audio analysis (e.g., using Librosa) to extract features like pitch and rhythm, and invokes a speech-to-text engine to obtain the text representation, saving both in the database.

### Step 7

The server performs emotion recognition using a machine learning model or emotion analysis API.

Input: Audio feature information, linguistic information.

Output: Emotional information associated with the audio data.

The server submits input features to an emotion recognition module, receives detected emotional state and appends this to the associated audio entry.

### Step 8

The server determines audio synthesis configuration information based on the recognized emotional information.

Input: Emotional information, audio feature information.

Output: Configuration information (such as pitch, rate, and tone for synthesis).

The server computes synthesis parameter adjustments—such as a brighter timbre for “joy” or a slower pace for “sadness”—and stores them as synthesis settings.

### Step 9

The server assigns unique identification information to the original audio data and associated records.

Input: Audio data or related metadata requiring identification.

Output: Updated database record with unique identification information.

The server generates a UUID or cryptographic code and links it to the data to facilitate traceability and authenticity.

### Step 10

The server synthesizes artificial audio using a text-to-speech synthesis engine based on the linguistic information, configuration information, and user-specific audio features.

Input: Linguistic information, configuration information, and audio feature information.

Output: Artificial audio file reflecting the user's voice and emotional expression.

The server provides these inputs to the synthesis engine, which generates the artificial audio file, and saves it for distribution.

### Step 11

The user requests the artificial audio by operating the application and selecting the desired entry for download.

Input: User selection and download request.

Output: Download request sent to the server identifying the specific artificial audio file.

The terminal processes the user's command and creates an authenticated HTTP GET request directed at the server.

### Step 12

The server processes the download request and transmits the artificial audio to the terminal.

Input: Download request specifying the artificial audio.

Output: Delivery of artificial audio file over the network to the terminal device.

The server locates the specified file, verifies access rights, and streams or transfers the file to the terminal.

### Step 13

The terminal receives and stores the artificial audio file, making it available for playback or further use.

Input: Artificial audio file received from the server.

Output: Artificial audio file stored in local storage and ready for playback.

The terminal confirms the transfer, saves the file locally (such as to internal storage or media folder), and enables playback through the device audio player.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

When providing voice-based services such as customer support, it is difficult to accurately determine the user's emotions from their speech and to generate synthetic voice responses that appropriately reflect those emotions. Conventional systems do not sufficiently analyze the emotional characteristics of user speech, nor do they provide a means for generating and storing synthetic voice data personalized based on the detected emotional state of the user. As a result, user satisfaction and service quality may be reduced due to inadequate emotional understanding and response.

The specific processing by the specific processing unit 290 of the data processing device 12 in Application Example 2 is realized by the following means.

The present invention provides a server including a processor configured to record acoustic information, transmit the acoustic information to an information processing apparatus, analyze the acoustic information to generate speaker feature information, convert the speaker feature information into text, extract emotion information from the text, set control information for voice generation based on the emotion information, assign individual identification information to the data, generate synthetic acoustic information according to the control information, transmit the generated acoustic information to a communication terminal, and enable playback and storage of the generated data. This enables highly accurate emotion analysis of user speech and the generation of emotion-reflective synthetic voice responses, thereby improving user satisfaction and service experience.

The term “acoustic information” refers to data representing sound, such as voice recordings or other audio signals, that are captured and processed by the system.

The term “storage medium” refers to any physical or virtual medium capable of storing digital data, including but not limited to memory chips, hard drives, flash storage, or cloud-based storage.

The term “information processing apparatus” refers to any computational device or server that is configured to receive, process, and analyze data.

The term “speaker feature information” refers to data extracted from acoustic information that characterizes the unique attributes of a speaker's voice, such as pitch, tone, rhythm, and speed.

The term “text data” refers to a series of symbols or characters that represent the content of spoken words transcribed from acoustic information.

The term “natural language analysis unit” refers to a component or process configured to analyze text data, such as to interpret meaning, context, or to extract emotional content from the text.

The term “emotion information” refers to data that represents the emotional state or characteristics inferred from text or acoustic information.

The term “control information for voice generation” refers to parameters or instructions that determine how synthetic voice will be generated, including aspects such as tone, speed, pitch, and style based on emotion information.

The term “individual identification information” refers to unique data, such as identifiers or codes, that are assigned to acoustic information or generated data to distinguish it from other data and to prevent unauthorized use.

The term “voice synthesis processing apparatus” refers to a computational system or software module that generates synthetic voice or audio signals based on control information and input data.

The term “communication terminal” refers to any end-user device, such as a smartphone, computer, or tablet, that is capable of sending, receiving, storing, or playing back data.

The term “playback” refers to the act or process by which generated acoustic information is rendered audible to a user through a communication terminal.

One embodiment for implementing the present invention will be described below.

A system according to the present invention includes a server, a terminal, and a user, each performing specific roles as described herein. The system enables the efficient processing and analysis of user voice input, emotion detection, and the generation and playback of synthetic voice that reflects emotional content.

The user operates a communication terminal, which may be a general-purpose mobile device such as a smartphone or tablet, running a dedicated application. This application is responsible for recording acoustic information, such as voice input, and temporarily storing it on a storage medium-typically the local memory or storage of the terminal.

The terminal uses software for audio capture and storage, commonly developed in programming environments such as Kotlin or Swift. The audio input is converted into a digital audio format, such as WAV or MP3, and stored in the device's internal memory. When the recording is complete, the terminal transmits the recorded acoustic information to a server via a network using HTTP protocol.

The server is implemented as an information processing apparatus, for example, a general-purpose computer or virtual server running an operating system such as Linux. The server uses software frameworks such as Flask or similar web frameworks for handling HTTP requests and responses. Upon receiving an audio file, the server temporarily stores the file and initiates processing.

For analysis, the server utilizes general-purpose application programming interfaces for speech recognition, such as a speech-to-text engine. An example of usable software is a cloud speech recognition API, which extracts speaker feature information (such as pitch, rhythm, and speaking rate) and generates a text transcript based on the received acoustic information.

The server then passes the resultant text data to a natural language analysis unit, implemented using services such as an emotion analysis API or natural language understanding engine. An example includes the use of a cloud-based emotion analysis service. The server obtains emotion information, such as “anger,” “joy,” or “sadness,” from the text data.

Based on the emotion data, the server sets control information for voice generation, determining such parameters as tone, speed, and pitch for the synthetic voice. The server also generates individual identification information for the stored audio and processed data using an ID generation algorithm or universally unique identifier library.

With these configurations, the server uses a voice synthesis processing module, such as a cloud-based text-to-speech API, to generate synthetic acoustic information that reflects both the original content and the recognized emotional state. The generated audio is stored and associated with its identification information.

When the user wishes to review or use the synthetic audio, the terminal sends a request to the server. The server transmits the synthesized audio data to the terminal, which stores it locally on a storage medium and allows the user to playback the content using an audio player component of the application.

As an example, if a user expresses a complaint to a food service support center using the terminal's application, the server may recognize an emotional state such as frustration or anger. It then generates a synthetic voice response with an appropriately adjusted apologetic tone and delivers it back to the user for review or submission. This system improves the accuracy of emotion detection and response, thereby enhancing user satisfaction.

An example of a prompt sentence that can be used with a generative AI model in this embodiment is as follows:

“Analyze the recorded user speech to detect emotional tone, rhythm, and speed. Recognize the user's emotion (e.g., joy, anger, sadness) and adjust the synthetic speech response accordingly: make the tone brighter and increase speed if joy is detected, render a slower and softer tone if sadness is detected. Output parameters for synthetic speech generation.”

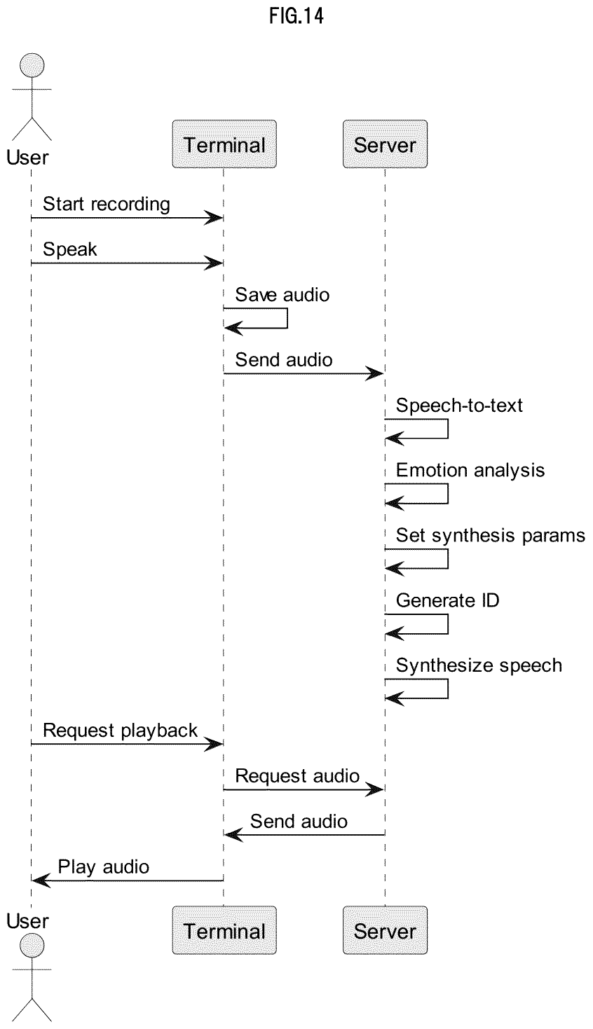

The following describes the processing flow using FIG. 14.

### Step 1

User launches the dedicated application on the terminal and selects the “Start Recording” option.

Input: User interaction with the app interface.

Output: Recording state is activated.

User speaks into the device microphone, and the terminal records the acoustic information as digital audio data, such as a WAV file.

The terminal saves the recorded audio file in its local storage.

### Step 2

Terminal retrieves the saved audio file from local storage and creates an HTTP POST request including the audio file as payload.

Input: Local audio file from previous step.

Output: HTTP POST request containing the binary audio data.

Terminal sends the request through the Internet to the server's specified endpoint.

### Step 3

Server receives the HTTP POST request from the terminal and extracts the audio file from the request body.

Input: HTTP request with audio data.

Output: Temporarily stored audio file on server.

Server saves the file into temporary server storage for further analysis.

### Step 4

Server processes the audio data by using a speech recognition engine, such as a cloud-based speech-to-text API.

Input: Audio file from server storage.

Output: Speaker feature information (pitch, speed, rhythm, etc.) and text transcript data.

Server sends the audio file to the recognition engine, receives extracted features and a transcript, and saves both to the database.

### Step 5

Server sends the text transcript to a natural language analysis unit, such as an emotion detection API, to perform emotion analysis.

Input: Text transcript from previous step.

Output: Emotion information (e.g., anger, joy, sadness) with analysis confidence.

Server processes the transcript, receives emotion labels, and adds these to the user session in the database.

### Step 6

Server sets the control parameters required for voice generation based on the detected emotion information.

Input: Emotion information from previous step.

Output: Control information for speech synthesis (e.g., synthesis pitch, tone, speed).

Server chooses and configures parameter values for synthetic voice output, tailored to the detected emotional state.

### Step 7

Server generates a unique identifier for the processed data using an ID generation algorithm.

Input: Current session and data context.

Output: Unique identifier linked to acoustic, text, and emotion data records.

Server updates all records in the storage by attaching this identifier for traceability and security.

### Step 8

Server initiates a voice synthesis process using a speech synthesis engine, such as a text-to-speech API, providing the transcript and control parameters as inputs.

Input: Transcript and control information for speech synthesis.

Output: Synthetic audio data reflecting the detected emotion.

Server receives the generated synthetic voice file, stores it in the database, and links it to the unique identifier.

### Step 9

User navigates in the app UI to the corresponding session and requests the download or playback of the generated synthetic audio.

Input: User selection in the application.

Output: Download or playback request sent to the server.

### Step 10

Terminal sends an HTTP GET request to the server including the unique identifier to retrieve the relevant synthetic audio.

Input: User's request with identifier.

Output: HTTP GET request sent to the server.

### Step 11

Server receives the GET request, retrieves the synthetic audio corresponding to the unique identifier from storage, and sends it to the terminal as an HTTP response.

Input: GET request with identifier.

Output: HTTP response with synthetic audio file.

### Step 12

Terminal receives the synthetic audio file, saves it in local storage, and makes it available for playback via the application's audio player.

Input: Received synthetic audio file.

Output: Audio file stored on terminal and accessible for playback.

User is able to listen to the generated synthetic voice reflecting their original emotional intent.

The data generation model 58 is a so-called generative artificial intelligence (AI).

Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14.

Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

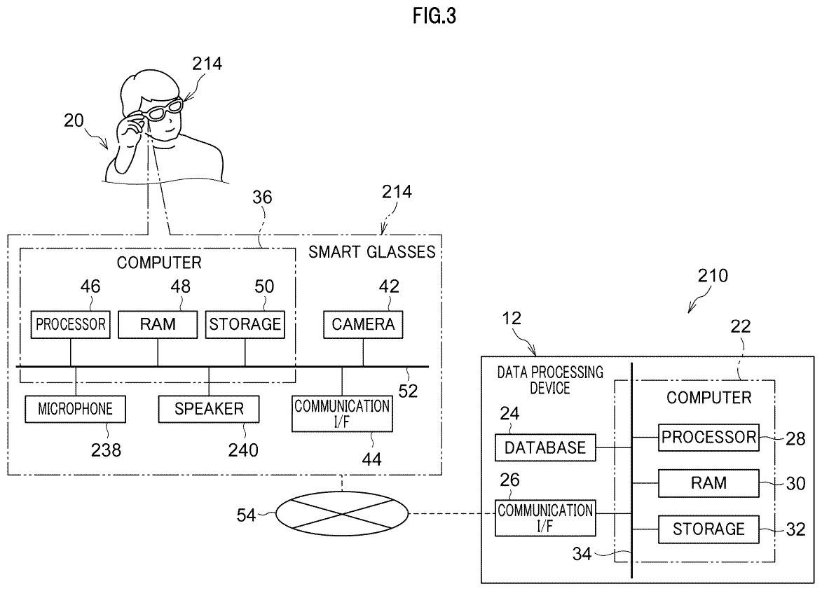

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46.

The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

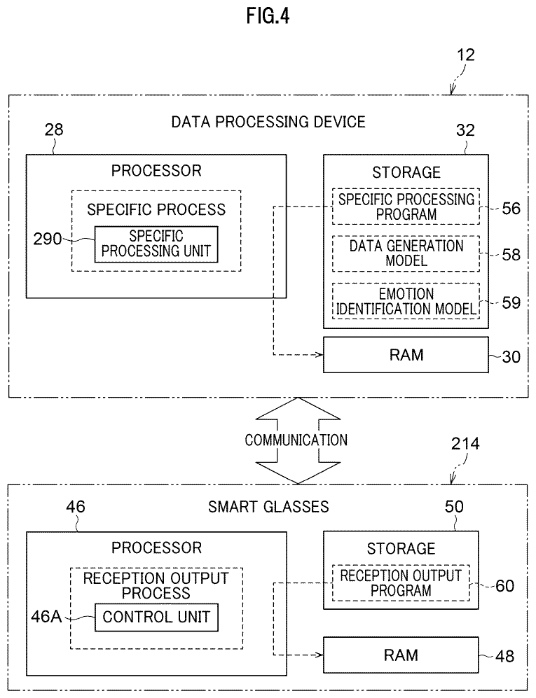

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

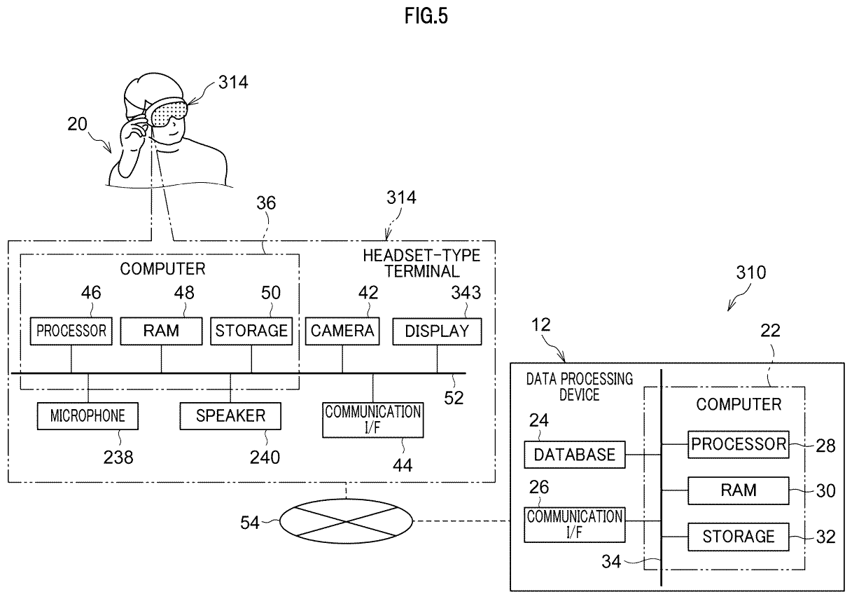

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication UF 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication UF 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46.

The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

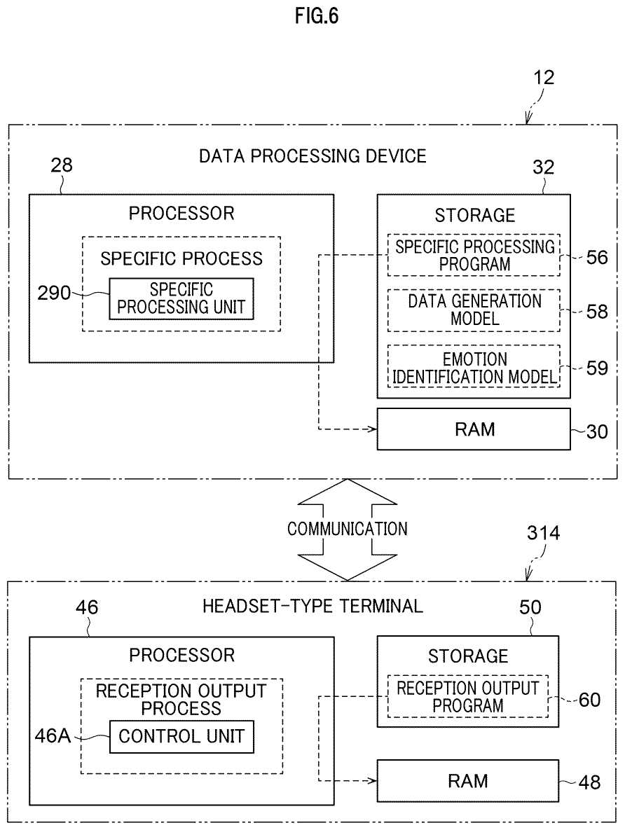

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI).

Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

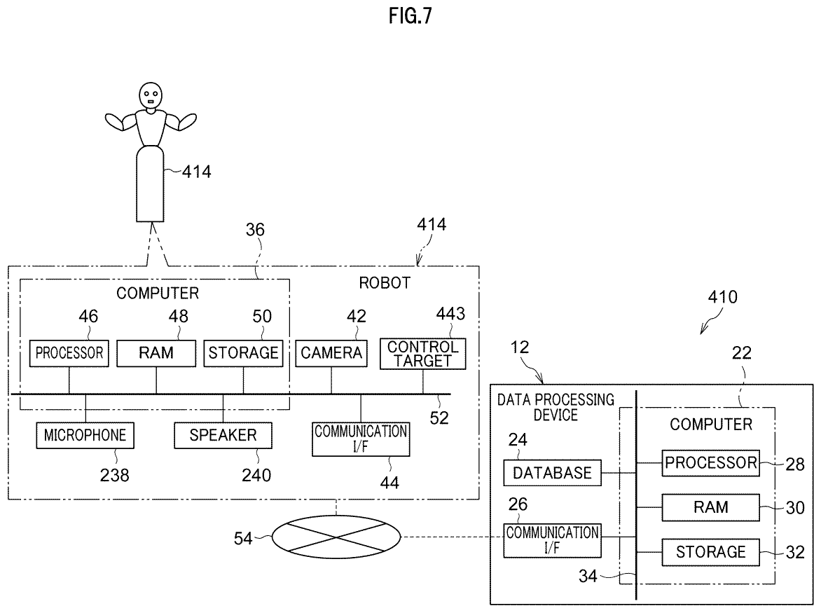

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

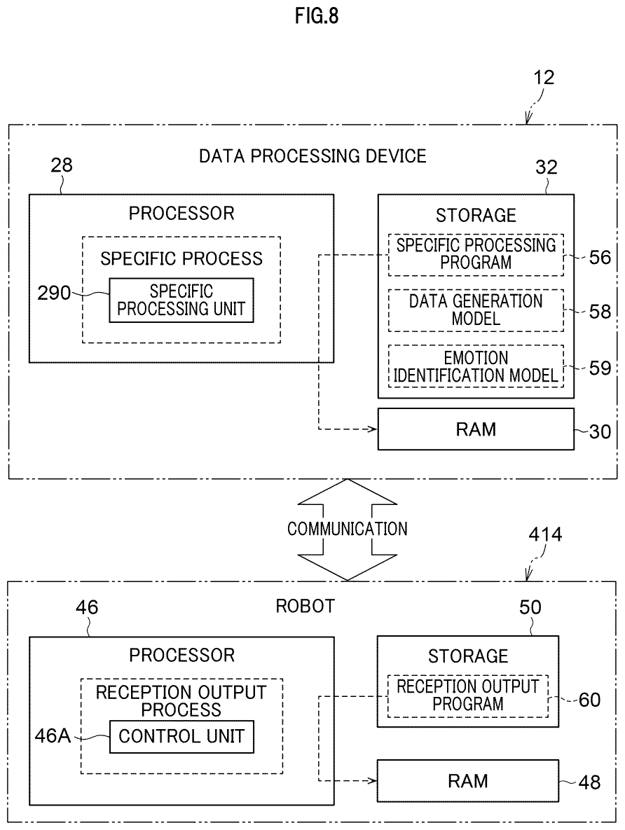

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

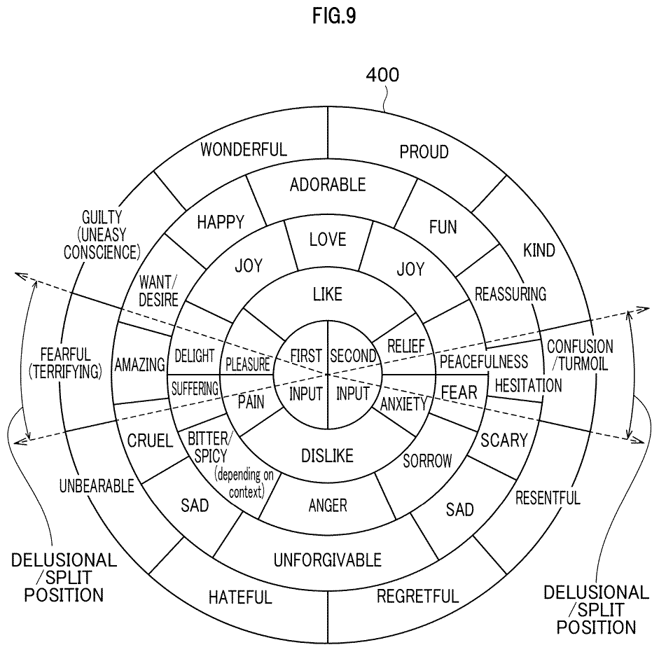

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

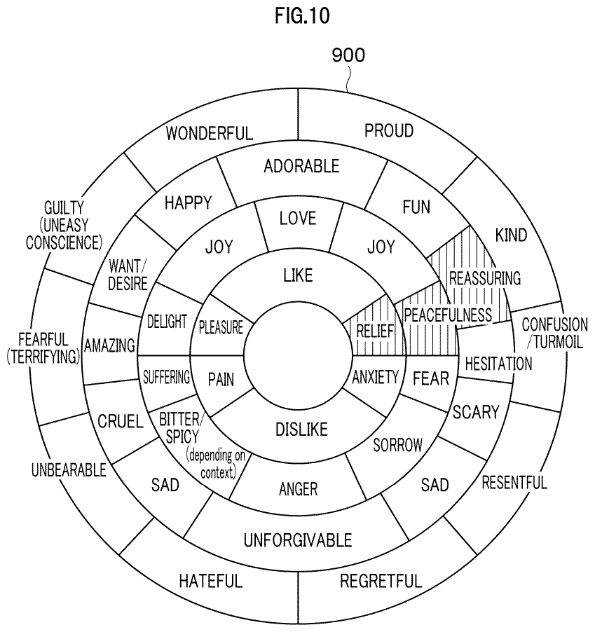

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system including a processor,
wherein the processor is configured to:
acquire acoustic information of a user,
transmit the acquired acoustic information to an information processing apparatus,
analyze the acoustic information at the information processing apparatus to generate acoustic feature information,
execute character encoding processing based on the acoustic feature information,
set control variables for synthesized acoustic information,
assign a unique code to the acoustic information,
generate synthesized acoustic information,
provide the generated acoustic information for user acquisition,
utilize a generative intelligence model in the generation of synthesized acoustic information, using a directive sentence as input to the model,
assign a unique identifier for rights management or distribution management to the generated acoustic information, and
automatically execute at least a part of the above processes in an integrated control manner.

### Supplementary 2

The system according to supplementary 1,
wherein the processor is configured to use an acoustic information recognition apparatus for analyzing the acoustic information.

### Supplementary 3

The system according to supplementary 1,
wherein the processor is configured to use a unique code generation computation process when assigning the unique code to the acoustic information.

### Application Example 1

### Supplementary 1

A system including a processor,
wherein the processor is configured to:
obtain audio information of a user using an information processing apparatus; transmit the obtained audio information to the information processing apparatus via a communication network;
analyze the received audio information to generate voice feature information;
generate linguistic information based on the voice feature information;
set control information for speech synthesis based on the voice feature information and emotion information;
assign individual identification information to the audio information;
generate speech synthesis information using the control information;
enable a user to acquire the generated speech synthesis information;
manage rights information related to utilization of the generated speech synthesis information;
store the voice feature information and emotion information in a storage device; provide unique identification information to the generated speech synthesis information;
transmit the generated speech synthesis information to a user terminal; and
manage playback or external provision by the user.

### Supplementary 2

The system according to supplementary 1,
wherein the processor is configured to use a speech recognition processing function or a generative artificial intelligence model in the analysis of the audio information and in the generation of the voice feature information.

### Supplementary 3

The system according to supplementary 1,
wherein the processor is configured to use a cryptographic algorithm or a digital identification generation processing function when assigning individual identification information to the speech synthesis information or to the audio information.

### Example 2

### Supplementary 1

A system including a processor,
wherein the processor is configured to:
acquire audio information of a user,
transmit the acquired audio information to an information processing device,
analyze the audio information to generate audio feature information,
convert the audio feature information into linguistic information,
recognize and add emotional information to the audio information using a machine learning device,
determine configuration information for artificial audio generation based on the recognized emotional information,
assign unique identification information to the audio information,
generate artificial audio based on the unique identification information and the configuration information, and
transmit the generated artificial audio information to a terminal device in response to an acquisition request from the user.

### Supplementary 2

The system according to supplementary 1,
wherein the processor is configured to use a speech recognition processing device in analyzing the audio information.

### Supplementary 3

The system according to supplementary 1,
wherein the processor is configured to use an identification information generation procedure when assigning the unique identification information to the audio information.

### Application Example 2

### Supplementary 1

A system including a processor,
wherein the processor is configured to:
record acoustic information to a storage medium,
transmit the acoustic information stored in the storage medium to an information processing apparatus,
analyze the acoustic information in the information processing apparatus to generate speaker feature information,
convert the speaker feature information into text data,
extract emotion information from the text data by using a natural language analysis unit,
set control information for voice generation based on the extracted emotion information,
assign individual identification information to the acoustic information,
generate acoustic information according to the control information by using a voice synthesis processing apparatus,
transmit the generated acoustic information to a communication terminal such that the terminal can store the generated acoustic information on a storage medium, and
enable playback of the generated acoustic information.

### Supplementary 2

The system according to supplementary 1,
wherein the processor is configured to use an acoustic recognition processing unit when analyzing the acoustic information in the information processing apparatus.

### Supplementary 3

The system according to supplementary 1,
wherein the processor is configured to assign individual identification information according to an identification information generation rule.

What is claimed is:

1. A system comprising a processor,
wherein the processor is configured to:
record a user's voice;
transmit the recorded voice to a server;
analyze the audio data at the server to generate a voice profile,
perform transcription based on the voice profile;
set parameters for voice synthesis;
assign a unique identifier to the audio data;
generate synthetic voice; and
enable the user to download the generated voice data.

2. The system according to claim 1, wherein the processor is configured to use a speech recognition engine in the analysis of the audio data.

3. The system according to claim 1, wherein the processor is configured to use an identifier generation algorithm when assigning the identifier to the audio data at the server.
